(19) United States
(12) Patent Application Publication
(10) Pub. No.: US 2020/0110870 A1
(43) Pub. Date: Apr. 9, 2020

(54) RISK ASSESSMENT FOR ACCOUNT AUTHORIZATION

(71) Applicant: CA, Inc., New York, NY (US)

(72) Inventors: Dhiraj Girdhar, Westborough, MA (US); Kathleen Hickey, Ashland, MA (US); Sandeep Kumar Ramnani, Shrewsbury, MA (US); Yashpal Singh Slathia, Bishnah (IN); Deepak Verma, Hyderabad (IN)

(21) Appl. No.: 16/154,643

(22) Filed: Oct. 8, 2018

(51) Int. Cl. G06F 21/45; G06F 21/31; H04L 29/06

(52) U.S. Cl. CPC G06F 21/45; H04L 63/108; H04L 63/107; G06F 21/316

(57) ABSTRACT

An embodiment of a system is disclosed in which a computer system may receive a sequence of failed login attempts to access a user account, and assess a risk level associated with the sequence of failed login attempts. The risk level may be assessed based on a plurality of characteristics of the sequence of failed login attempts. Based on the assessed risk level, the computer system may select a lockout policy that includes a lockout period. The computer system may determine that a lockout threshold, corresponding to a number of failed login attempts, has been reached. In response to determining that the lockout threshold has been reached, the computer system may prevent further login attempts during the lockout period. In addition, the computer system may permit subsequent login attempts after the lockout period has ended.

### BACKGROUND

### Technical Field

Embodiments described herein are related to the field of user account security, and more particularly to assessing a risk level to a user logging into an account.

### Description of the Related Art

Using computer systems, such as, for example, personal computers (PCs), laptops, smart phones, tablets, and other mobile and/or wearable devices, users may access a wide variety of data servers, cloud storage servers, online retailers, social media sites, and other networked computer services which may store sensitive information. These networked computer services may require the user to provide account credentials in order to access the sensitive information. A common recommendation to improve the security of various accounts used by a given user is to use a different passcode for each account. In the event a passcode for a first account is obtained by a hacker, using different passcodes prevents access by the hacker into the other accounts.

One disadvantage of using multiple passcodes is that a user may forget or confuse passcodes for one or more accounts. Many account services currently allow a user a particular number of attempts to provide a correct passcode before locking the account, i.e., preventing anyone, regardless if correct account credentials are provided, from accessing the locked account. The locked account may be locked for a period of time or until an account user contacts a provider of the account to confirm an approved identity associated with the account. For a legitimate user of the account, a time-consuming lockout period may prevent the user from accomplishing a desired or necessary task.

### SUMMARY OF THE EMBODIMENTS

Various methods for embodiments of computer systems are disclosed. Broadly speaking, embodiments of systems are disclosed in which a computer system may receive a sequence of failed login attempts to access a user account, and assess a risk level associated with the sequence of failed login attempts. The risk level may be assessed based on a plurality of characteristics of the sequence of failed login attempts. Based on the assessed risk level, the computer system may select a lockout policy that includes a lockout period. The computer system may determine that a lockout threshold, corresponding to a number of failed login attempts, has been reached. In response to determining that the lockout threshold has been reached, the computer system may prevent further login attempts during the lockout period. In addition, the computer system may permit subsequent login attempts after the lockout period has ended.

In some implementations, the lockout policy may specify the lockout threshold, wherein the lockout threshold is based on the assessed risk level. In particular implementations, the risk level may be one of a set of specified risk levels, and the lockout period may be one of a set of specified lockout periods. The lockout policy may be selected such that successively increasing risk levels correspond to successively increasing lockout periods.

In various embodiments, the assessing of the risk level may include increasing the assessed risk level in response to determining that the sequence of failed login attempts has occurred at a time of day at which the user account has not been previously accessed. In some embodiments, the assessing may include increasing the assessed risk level in response to determining that the sequence of failed login attempts has occurred at a geographic location from which the user account has not been previously accessed.

In particular implementations, in response to receiving a successful login attempt to the user account, the computer system may initiate a communication session to the user account. The computer system may then assess a session risk level associated with the communication session, and then determine, based on the assessed session risk level, a session timeout period for the communication session.

### BRIEF DESCRIPTION OF THE DRAWINGS

The following detailed description makes reference to the accompanying drawings, which are now briefly described.

FIG. 1A illustrates an embodiment of a system for determining a lockout policy based on a sequence of failed login attempts.

FIG. 1B shows an embodiment of a system for determining a session timeout policy based on characteristics associated with a communication session.

FIG. 2 depicts an embodiment of a system for determining an amount of time for implementing a lockout period.

FIG. 3 illustrates an embodiment of a system for determining number of failed login attempts to allow before implementing a lockout period.

FIG. 4 shows an embodiment of a system for establishing a session timeout period for a communication session.

FIG. 5 depicts a flow diagram for an embodiment of a method for setting a lockout period in response to a sequence of failed login attempts.

FIG. 6 illustrates a flow diagram for an embodiment of a method for establishing a lockout threshold in response to a sequence of failed login attempts.

FIG. 7 depicts a flow diagram for an embodiment of a method for determining a session timeout period for an established communication session.

FIG. 8 shows a flow diagram for an embodiment of a method for selecting a lockout policy based on characteristics of received login attempts.

FIG. 9 illustrates two charts associated with an embodiment of a system for selecting and implementing a lockout of a user account.

FIG. 10 depicts two charts illustrating activity of an embodiment of a system for implementing a session timeout of a communication session.

FIG. 11 shows an embodiment of a computing device that may be used in the systems shown in the previous figures.

While the embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

As used throughout this disclosure, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

### DETAILED DESCRIPTION OF EMBODIMENTS

Providers of various accounts, such as financial institutions, cloud storage providers, online retailers, social media companies, and the like, may attempt to strike a balance between protecting user accounts from fraudulent access and providing easy to use services. These providers, therefore, may encourage use of complex and unique passcodes as part of account credentials used to login to a particular online account. As used herein, “account credentials,” or simply “credentials,” refers to information sent to a computer system to gain access to a user account managed by the computer system. For example, account credentials may include a user name or email address in combination with a passcode. In some embodiments, credentials may further include a secondary code sent to a different device of the user, such as in a two-factor authorization procedure. In various embodiments, the passcode may be generated by a computer or selected by the user.

Complex passcodes may be more difficult for hackers to discover, thereby improving a level of security for the online account. These complex passcodes, however, may also be difficult for some users to remember, resulting in legitimate users occasionally entering incorrect account credentials when logging into the online account. If the user enters incorrect credentials more than a threshold number of times, the user may be locked out of the online account for some period of time. In order to improve the user experience, some account providers may desire to increase the threshold number of failed attempts before locking initiating a lockout period, and/or reduce a length of the lockout period for approved users who have simply forgotten their correct account credentials. In contrast, however, account providers may want to decrease the threshold number and/or increase a lockout period for a hacker attempting to gain unapproved access to another user's account by repeatedly guessing values for the account credentials.

While some hackers may attempt to determine a user's passcode to gain access to the user's account, other hackers may attempt to hijack an active session. “Session hijacking” refers to methods of tricking a computer system that is hosting an active session between a user and user account. When a user successfully logs into a user account hosted by a computer system, the computer system may send a token (e.g., a cookie, a session key, and the like) to the user's device to be used to indicate a valid communication session when the user's device and the computer system transfer information between each other. A hacker may hijack this communication session by determining the value of the token and then communicating with the computer system using the token to trick the computer system into accepting the hacker's communication as a communication from the logged in user, thereby gaining access to the user's account. One method to mitigate against session hijacking is to request a re-authentication after a predetermined amount of time, referred to herein as a session timeout period. Assuming the hacker only has the value of the session token and not the user's account credentials, the hacker would most likely fail to re-authenticate and the communication session can be terminated. In some embodiments, the approved user may be alerted (e.g., by email or text message) to the failed re-authentication.

Methods and systems are disclosed herein which may allow online account providers to determine a risk level associated with a particular login attempt based on characteristics of the particular login attempt. Using this determined risk level, the online account providers may be able to improve the user experience for approved users when the risk level is low by increasing thresholds for initiating lockouts and reducing lockout times when the threshold is reached. When a risk level is high, the online account providers may invoke a comparatively high-security policy (as opposed to other possible security policies) that reduces the threshold for initiating a lockout and increases the lockout period when the threshold is reached.

It is noted that, as used herein, “online” refers to a connected state of a server computer, computer system, mobile device, or other computing device, to a wide area network, such as, for example, the Internet. A computing device said to be “online” when it is capable of being accessed by, or accessing, other computing devices connected to the network. In reference to an account, “online” refers to an account that is hosted by an online server or other type of online computing device, and, accordingly, may be accessed via the wide area network.

Embodiments described below are generally directed to an account login process in which a computer system receives a sequence of failed login attempts from a user of a computing device. The computer system assesses a risk level associated with the sequence of failed login attempts, basing the risk level on a plurality of characteristics of the sequence of failed login attempts. Characteristics that may be considered for determining the risk level include, for example, a location of the user, a time of day of the attempt, an identification value associated with the computing device, a network to which the computing device is connected. In various embodiments, this risk level may be used to select a lockout policy that determines when and for how long an account may be locked in response to a number of failed login attempts, as well as determining a session length if a successful login attempt is received.

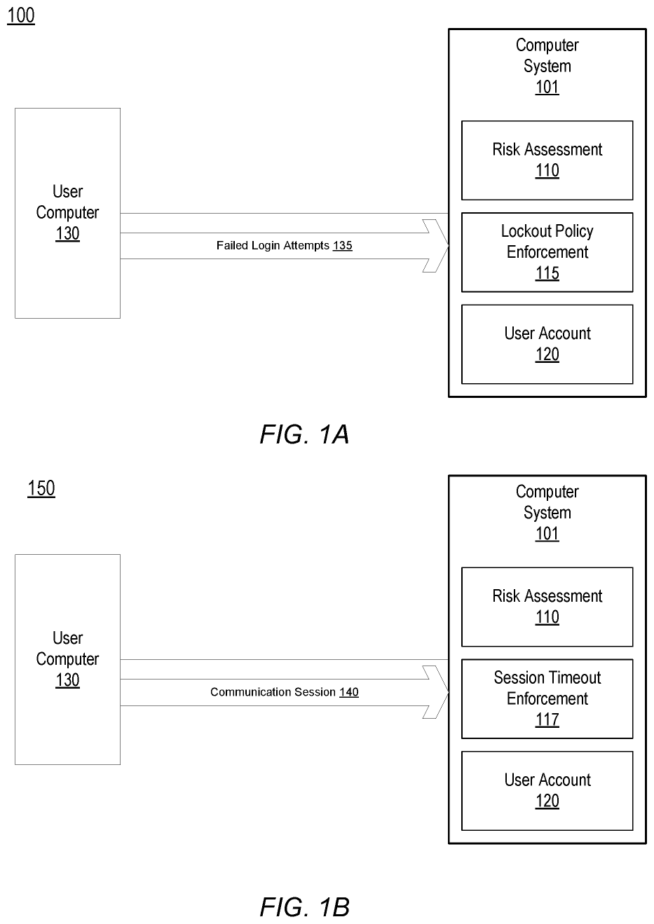

Two embodiments of a system that includes networked computer systems are shown in FIGS. 1A and 1B. Systems 100 and 150 of FIGS. 1A and 1B, respectively, include computer system 101 and user computer 130. As shown in FIG. 1A, computer system 101 includes risk assessment module 110, and lockout policy enforcement module 115. In FIG. 1B, computer system 101 includes session timeout enforcement module 117 in addition to risk assessment module 110. In both FIGS. 1A and 1B, computer system 101 provides access to user account 120 by user computer 130.

As illustrated in FIG. 1A, computer system 101 receives a sequence of failed login attempts 135 from user computer 130. User computer 130 may utilize any suitable computing device to generate failed login attempts 135, such as a desktop computer, a laptop, a smartphone, a tablet, and the like. User computer 130 may communicate to computer system 101 via the Internet using a wired connection, a wireless connection or a combination thereof. Computer system 101 uses risk assessment module 110 to assess a risk level associated with failed login attempts 135 based on a plurality of characteristics of the failed attempts. In various embodiments, computer system 101 may initiate risk assessment module 110 after receiving a first failed attempt of failed login attempts 135, or may wait until multiple failed login attempts have been received.

The assessed risk level is provided to lockout policy enforcement module 115. Using the assessed risk level, lockout policy enforcement module 115 selects a corresponding lockout policy. As used herein, “lockout policy” refers to any set of rules relating to a lockout of a user's account. The selected lockout policy may include one or more parameters used to determine how and when access to user account 120 may be locked. In some embodiments, the lockout policy may include a lockout threshold that indicates a number of failed login attempts 135 that are allowed until user account 120 is locked. In other embodiments, the lockout policy may include, in addition to or in place of the lockout threshold, a lockout period that indicates an amount of time that user account 120 remains locked after the lockout threshold has been reached. Once the lockout period has expired, user computer 130 may once again attempt to access user account 120. Still further, the lockout policy might specify further restrictions on logging into a user's account, such as requiring access from a particular computing device to gain access, or a certain level of multi-factor authentication.

FIG. 1B shows computer system 101 after user computer 130 has successfully entered login credentials for user account 120. After user computer 130 sends correct login credentials for user account 120, computer system 101 initiates communication session 140, allowing user computer 130 access to data and/or services associated with user account 120. For example, if user account 120 corresponds to a banking account, then user computer 130 may access account balances, transfer funds, pay bills, and the like. If user account 120 corresponds to a cloud computing account, then user computer 130 may perform various actions on files stored in the cloud account, such as download, upload, read, and/or edit the files.

Computer system 101, as shown, includes session timeout enforcement module 117 to determine if and when user computer 130 will be requested to perform a re-authentication. A “re-authentication,” as used herein, corresponds to a request for an account user to re-enter login credentials to help determine that an authorized user is still accessing account. Computer system 101 uses risk assessment module 110 to determine a session risk level. The assessed risk level is then used by session timeout enforcement module 117 to determine a session timeout period. A high assessed risk level results in a shorter session timeout period, while a low assessed risk level results in the opposite.

As shown in both FIGS. 1A and 1B, risk assessment module 110 assess a risk level associated with failed login attempts 135 based on a plurality of characteristics of the failed attempt. In various embodiments, the risk level may be determined as a numeric value (e.g., ranging from 0 to 255) or may indicate one of a set of predetermined risk levels (e.g., “low,” “medium,” or “high”). Any suitable range of values or number of risk levels may be implemented.

One characteristic that may be utilized is a time of day when a failed login attempt occurs. Risk assessment module 110 may increase the risk level in response to determining that the sequence of failed login attempts 135 has occurred at a time of day at which an approved user has rarely or never logged in previously. For example, if an approved user typically logs into user account 120 between 9:00 AM and 5:00 PM on Mondays through Fridays, then a failed login attempt that occurs at 1:00 AM on a Sunday may be suspicious and result in an increase to the assessed risk level.

Risk assessment module 110 may also increase the assessed risk level in response to determining that the sequence of failed login attempts 135 has occurred at a geographic location from which the approved user has never or has very rarely logged in previously. For example, if the approved user typically logs into user account 120 from a location in New York City, but failed login attempts 135 originate from a location in London, then the assessed risk level may be increased. In some embodiments, any login attempt, successful or failed, from a new location may be assessed as a high risk attempt. Location information may be determined by various methods. If a user's computing device includes a global positioning system (GPS) circuit, then GPS information may be retrieved from the computing device. For devices without GPS, location information may be determined based on identifying a particular Internet access point or Internet protocol (IP) address used to send failed login attempts 135. For example, public databases that include access point network addresses and their geographic locations are available and may be utilized by risk assessment module 110 to identify a location of user computer 130.

In some cases, the approved user may provide information to computer system 101 during an authorized communication session to generate a list of approved locations from which a login to user account 120 may be made. A failed login attempt from another location may result in the risk level being set to a highest possible value. The approved user may also provide information to computer system 101 to indicate a travel itinerary, thereby creating a temporary list of alternate acceptable locations from which user account 120 may be accessed without increasing the risk level. In contrast, if a sudden change in a user's location is detected, then the risk level may be increased. For example, if user account 120 is successfully accessed by the approved user in New York City and a failed login attempt is received from San Francisco an hour later, then risk assessment module 110 may increase the assessed risk level even if the approved user has previously logged in from San Francisco.

Another characteristic that risk assessment module 110 may utilize is an identification value of a computing device used by user computer 130. Risk assessment module 110 may increase the assessed risk level in response to determining that the identification value of the user computer has not been previously associated with the user account. A computing device may be identified using any of a number of various device attributes associated with the computer device such as a media access control (MAC) address, an IP address, an operating system (OS) type, an OS version, a browser type or other user agent type, a browser version, particular fonts installed on system, and the like. In some cases, these attributes may identify a particular type of device utilized by the user, while other attributes may identify one computing device.

As an example of utilizing an identification value, a MAC address of a computing device being used by user computer 130 may be compared to a list of MAC addresses of computing devices previously used by the approved user. If the MAC address associated with user computer 130 does not match a MAC address in the list, then risk assessment module 110 increases the value of the risk level. Otherwise, risk assessment module 110 may reduce or maintain a current value of the risk level.

In addition to using an identification value of a computing device to determine the risk level, risk assessment module 110 may increase the risk level in response to determining that an identification value of a network used by user computer 130 has not been previously associated with user account 120. If user computer 130 sends, to computer system 101, failed login attempts 135 via a network that has not been previously associated with user account 120, then risk assessment module 110 may increase the value of the risk level. For example, if the approved user typically accesses user account 120 via a Verizon mobile network and failed login attempts 135 are received from a Comcast cable network that has never been used with user account 120, then risk assessment module 110 may increase the value of the risk level. Risk assessment module 110 may be capable of identifying a particular Internet service provider (ISP) from which failed login attempts 135 are received and may maintain a list of ISPs used for successful login attempts.

Risk assessment module 110 may also determine the risk level based on the credentials used in failed login attempts 135. In particular, risk assessment module 110 may consider how close a passcode portion of received failed login attempt is to the valid passcode for user account 120. A received invalid passcode that is the same as the valid passcode except for one or two characters may result in risk assessment module decreasing the value the risk level. Similarly, an invalid passcode that matches a previously valid passcode (e.g., the approved user recently changed the passcode) may result in a decreased or same value of the risk level. In contrast, an invalid passcode that is not similar to the valid passcode or a previously used passcode may result in an increase in the value of the risk level.

Referring to FIG. 1B, after communication session 140 is established, risk assessment module 110 may continue to monitor one or more characteristics associated with user computer 130 to detect suspicious activity that might indicate a session hijacking attempt. Risk assessment module 110 may track operations performed by user computer 130 in respect to user account 120. For example, actions such as reading, copying, deleting, modifying files in a cloud computing account may be tracked. In a financial account, transferring funds out of the account may be tracked. In response to detecting unusual or suspicious behavior by user computer 130 (e.g., copying a large number of files from a cloud account to a computing device of user computer 130 followed by deleting the files in user account 120, or transferring a large sum of money from a financial account to an unfamiliar bank account), risk assessment module 110 may increase a current value of the risk level, resulting in a shorter session timeout period and requiring user computer 130 to re-authenticate more frequently.

Another characteristic that may be tracked during communication session 140 is a geographic location of user computer 130. Using methods described above, risk assessment module 110 may periodically verify a current location of user computer 130. Risk assessment module 110 may increase the current risk level based on a determination that a geographic location of the user has changed during the communication session. For example, if the location of user computer 130 is verified every ten minutes and the location changes from London to Paris between successive verifications, this is a strong indication that the session has been hijacked and the risk level may be increased, and the session timeout period may be decreased, in some cases to zero to initiate a session re-authentication at an earliest opportunity.

The above disclosed procedures and characteristics for detecting risk in a communication session represent a limited number of examples. It is contemplated that other characteristics and procedures may be utilized in other embodiments.

Computer system 101, as illustrated, may correspond to any suitable computing system coupled to a computing device of at least one user and capable of providing access from the user computing device to data and/or services of a user account. In some embodiments, computer system 101 may include a plurality of computers, such as a server farm or data center. Risk assessment module 110, lockout policy enforcement module 115, and session timeout enforcement module 117 may each be implemented as software executing on computer system 101 and/or hardware coupled to or included in computer system 101.

By using a risk assessment to determine a risk level of user logging into or already logged on to a user account, a computer system may provide a higher level of security against hacking attempts while decreasing a level of frustration experienced by an approved user. Determining a risk level for a user attempting to login may allow the computer system to enable stricter security measures when the risk level is relatively high, potentially discouraging or preventing a hacker from gaining unapproved access to the user account. In contrast, when a risk level is relatively low, an approved user who simply forgot correct credentials for the user account may be given more opportunities to try various versions of credentials until the correct credentials are determined, thereby granting access to the approved user. Using risk assessment with a user that is logged into an active communication session may help to protect the communication session from being hijacked by an unapproved user. A low-risk assessment may allow the computer system to reduce or eliminate intrusive requests to re-authenticate an approved user, while a high-risk assessment may detect a session hijacking attempt more quickly and possibly reduce or prevent unauthorized access to the information and/or services provided by the user account.

It is noted that FIGS. 1A and 1B are merely examples for demonstrating disclosed concepts. Only components necessary to illustrate these concepts are shown in FIGS. 1A and 1B. Additional and/or different components or modules may be included in other embodiments. Embodiments that include a combination of features from both FIG. 1A and FIG. 1B are contemplated.

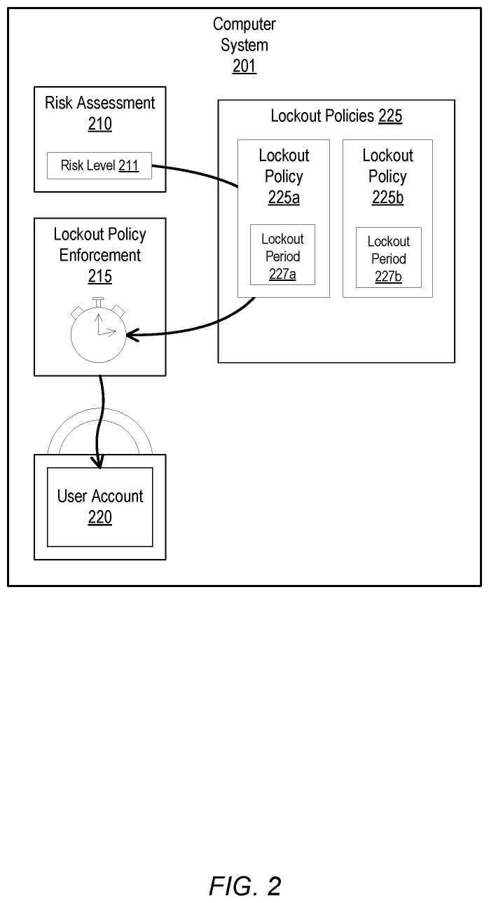

As described above, a computer system may implement a lockout policy that includes a lockout period to protect a user account from a hacker attempting to gain access by repeatedly guessing account credentials. Moving to FIG. 2, an embodiment of such a computer system is shown. Computer system 201 includes risk assessment module 210 and lockout policy enforcement module 215. Computer system 201 provides access to user account 220 after receiving valid account credentials for the account. Computer system 201 also includes a plurality of lockout policies 225. Two lockout policies 225 are shown: lockout policies 225a and 225b. Computer system 201 may, in some embodiments, correspond to computer system 101 in FIG. 1, including the similarly named and numbered modules. Except as described otherwise, the functionality of these elements is as described in regards to FIG. 1.

As illustrated, after computer system 201 receives one or more failed login attempts from a user, such as user computer 130 in FIG. 1, computer system 201 uses risk assessment module 210 to assesses risk level 211 associated with the user. In some embodiments, computer system 201 may initiate risk assessment module 210 after a first failed login attempt is received, or after a predetermined number of login attempts are received. In other embodiments, risk assessment module may be active for a login attempt before a success or failure determination is made. Risk assessment module 210 assesses risk level 211 based on a plurality of characteristics of failed login attempts, as described above. As described above, risk level 211 may be determined as a numeric value, or may indicate one of a set of predetermined risk levels.

Based on assessed risk level 211, computer system 201 uses lockout policy enforcement module 215 to select a lockout policy 225. For example, lockout policy 225a may correspond to a “high” value of risk level 211 while lockout policy 225a corresponds to a “low” risk value. Each lockout policy 225 may include corresponding values for one or more parameters associated with determining when and for how long to lock a user account due to a determined security risk. Lockout policies 225 may also include respective methods for unlocking a locked account after a lock has been initiated on an account.

As illustrated, a value of risk level 211 causes lockout policy enforcement module 215 to select lockout policy 225a, which may include lockout period 227a. After determining that a number of successive failed attempts to login to user account 220 reaches a lockout threshold, lockout policy enforcement module 215 prevents further login attempts to user account 220 for a time duration that is set based on lockout period 227a. Once a period of time corresponding to lockout period 227a has ended, lockout policy enforcement module 215 permits subsequent login attempts to user account 220. If lockout policy 225a corresponds to a high risk level 211 and lockout policy 225b corresponds to a low risk level 211, then lockout period 227a may indicate a longer time duration than lockout period 227b. A higher risk level, therefore, may result in a longer lockout period, potentially increasing an amount of time for a hacker (or a machine acting on a hacker's instructions) to attempt to guess login credentials for the user account. A sufficiently long lockout period may deter a hacker from continued attempts to gain access to the user account.

It is noted that the embodiment of FIG. 2 is one example. Although a single computer system 201 is illustrated, computer system 201 may include a plurality of computer devices, such as an array of server computers. The functions described for risk assessment module 210 and lockout policy enforcement module 215 may be implemented by any suitable combination of hardware and software.

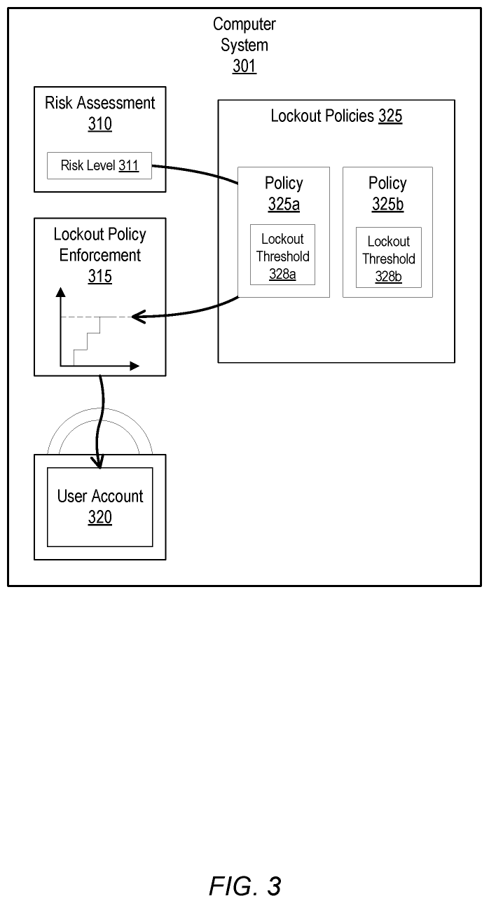

FIG. 2 depicts an embodiment for determining a lockout period based on an assessed risk level. Turning to FIG. 3, an embodiment of a computer system that determines a lockout threshold based on an assessed risk level is illustrated. Computer system 301 includes risk assessment module 310 and lockout policy enforcement module 315 and provides access to user account 320. Computer system 301 also includes lockout policies 325 with two illustrated: lockout policies 325a and 325b. Computer system 301 may, in some embodiments, correspond to computer system 101 in FIG. 1, or computer system 201 in FIG. 2. Except as described otherwise, the functionality of the illustrated elements is as described above.

After receiving a failed login attempt, computer system 301, as shown, uses risk assessment module 310 to determine risk level 311. As described above, risk assessment module 310 uses various characteristics of the failed login attempt to determine risk level 311. In addition, risk assessment module 310 may adjust risk level 311 after receiving subsequent failed login attempts. Risk level 311 may be used by lockout policy enforcement module to select one of lockout policies 325. Each lockout policy 325 includes a respective lockout threshold 328 (lockout thresholds 328a and 328b are illustrated).

As illustrated, lockout policy enforcement module 315 uses the selected lockout policy 325 to set a lockout threshold to a particular value. For example, if lockout policy 325a is selected, then the lockout threshold value is based on lockout threshold 328a. Lockout policy enforcement module 315 uses lockout threshold 328a to determine how many failed login attempts may be allowed before locking user account 320. For example, if lockout threshold 328a is three, then after receiving a third failed login attempt, lockout policy enforcement module 315 causes user account 320 to be locked for a period of time (as described above).

As risk level 311 may be adjusted as additional failed login attempts are received, the selected lockout policy 325 may change, e.g., from lockout policy 325b to lockout policy 325a. Depending on the characteristics of the additional failed login attempts, risk level 311 may increase or decrease. For example, if a sequence of failed login attempts is received that includes a previous version of a valid passcode, and one or more versions of the current valid passcode with minor deviations, risk assessment module 310 may lower a value of risk level 311, assessing that the user submitting the passcodes is an approved user and has merely forgotten the correct passcode. The lower value of risk level 311 may result in a change from lockout policy 325a to lockout policy 325b. In some cases, corresponding lockout threshold 328b may be greater than lockout threshold 328a, thereby allowing the user to submit additional incorrect passcodes before locking the account. If one of these additional attempts includes the correct passcode, then the user may be granted access to user account 320 without being delayed by a lockout period.

In contrast, if additional failed login attempts result in risk assessment module 310 increasing the value of risk level 311, then a new lockout policy 325 may be selected with a reduced value for the lockout threshold. In some cases, it may be possible for the lockout threshold to be reduced to a value that causes lockout policy enforcement module 315 to lock user account 320 before another login attempt can be received. For example, a current lockout threshold may be set to five attempts based on lockout threshold 328b. After receiving three successive failed login attempts, risk assessment module 310 may increase risk level 311 to a value that causes a change from lockout policy 325b to lockout policy 325a. If the value of lockout threshold 328a is one, two, or three, then lockout policy enforcement module 315 may lock user account 320 before accepting a fourth login attempt, regardless if the fourth attempt includes the correct credentials. If the user submitting the login attempts is a hacker, then the reduction of the value of the lockout threshold may provide fewer attempts for the hacker to gain unapproved access to user account 320, and may discourage the hacker from continuing efforts to access the account.

It is noted that the embodiment of FIG. 3 is one example. In other embodiments, any suitable number of lockout policies may be included. It is contemplated that features disclosed in FIG. 3 may be combined with the features disclosed in FIG. 2. For example, the lockout policies may include both lockout thresholds and lockout periods.

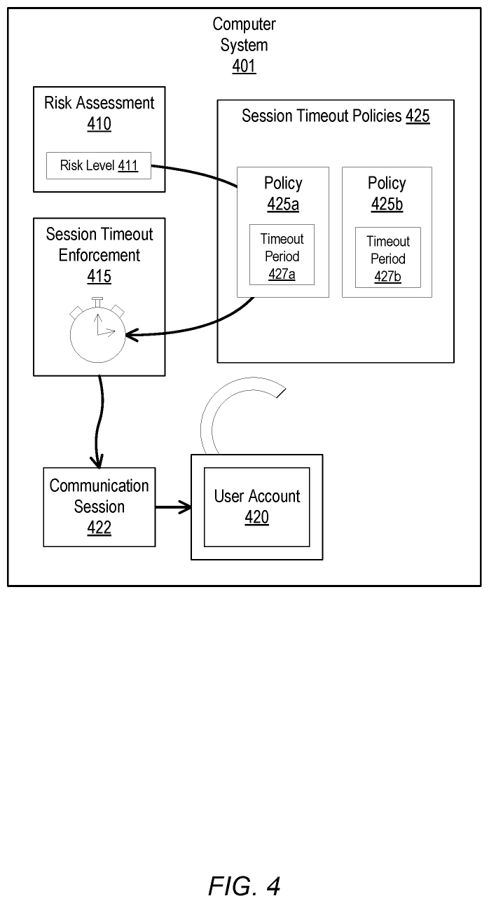

As described above, after a communication session is established, a computer system may continue to monitor characteristics associated with the user to detect suspicious activity that might indicate a session hijacking attempt. Proceeding to FIG. 4, an embodiment of a computer system that monitors a communication session to detect suspicious activity is depicted. Computer system 401 may, in various embodiments, correspond to any of computer systems 101, 201, or 301 as described in regards to in FIG. 1, 2, or 3. Functionality of the elements illustrated in FIG. 4 is as described for similarly named and numbered elements above, except as noted below. Computer system 401 includes risk assessment module 410 and session timeout enforcement module 415 and provides access to user account 420. Computer system 401 also includes session timeout policies 425 with two illustrated: session timeout policies 425a and 425b.

After receiving valid account credentials from a current user, computer system 401 establishes communication session 422 to user account 420 and then uses risk assessment module 410 to assess a session risk level associated with communication session 422. An initial risk level 411 may be based on a previously determined risk level, such as risk level 211 or 311 that were determined during an account login process. In some embodiments, risk assessment module 410 may include additional information made available after a previous risk level was determined, for example, a total number of failed login attempts received from the current user before the valid credentials were received. Computer system 401 then uses session timeout enforcement module 415 to determine a session timeout period for communication session 422. Session timeout enforcement module 415 may correspond to lockout policy enforcement modules 215 or 315, or may include different software and/or circuits to perform described functions.

As shown, session timeout enforcement module 415 enforces a timeout period for communication session 422 to protect against session hijacking. When the timeout period expires, the current user may be requested to re-authenticate by entering the valid account credentials. If the current user is the approved user who entered the valid credentials, then this current user should be able to enter the valid credentials and continue communication session 422. If, however, the current user is a hacker who has hijacked communication session 422, e.g., by spoofing (copying) a MAC address or other value that computer system 401 uses to identify the approved user's computing device, then the hacker may not have the valid account credentials and, accordingly, fail to re-authenticate, at which point, communication session 422 may be terminated. In some embodiments, available information about the hacker's computing device or location may be logged.

For an approved user, the act of re-authenticating may be a nuisance and/or may interrupt the approved user's workflow within a communication session. It therefore may be desirable to grant users that are deemed more likely to be authorized users longer session timeout periods to minimize such interruptions. In contrast, a suspect user should be given comparatively shorter session timeout periods to hijack a session, thus minimizing an amount of data or services a hacker can access. Computer system 401, therefore, determines the timeout period based on risk level 411. As illustrated, session timeout enforcement module 415 uses a value of risk level 411 to select one of session timeout policies 425. Two session timeout policies are shown (425a and 425b), although, any suitable number may be included. Each session timeout policy 425a and 425b includes a respective session timeout period 427a and 427b. In some embodiments, risk level 411 may be assigned one of a set of levels (e.g., low, medium, high), each with a respective session timeout policy. In other embodiments, risk level 411 may be assessed a numeric value and the session timeout policy 425 is selected based by comparing this value to one or more threshold values.

A higher risk level 411 (which represents a greater risk that a session is unauthorized) results in a session timeout policy 425 with a shorter timeout period being selected, and vice versa. For example, if the user enters the valid account credentials correctly on a first login attempt, is logging in to user account 420 during a typical time of day and from a typical location, is using a network and a computing device that has been previously used to access user account 420, and various other security criteria are met, then risk level 411 may be assigned a lowest risk value. A selected session timeout policy may then have a longest allowable session timeout period, which, in some embodiments, may correspond to no timeout period, i.e., the user will not be asked to re-authenticate. As another example, if the user has multiple failed login attempts and initiates a lockout period before successfully sending the valid account credentials, is logging in from an unknown location and/or from an unknown computing device or network, and/or other risks criteria are detected, then risk level 411 may be assigned a highest risk value. A session timeout policy selected under such conditions may, therefore, have a relatively short session timeout period. It is contemplated that, in some embodiments, a highest risk level may include blocking access to user account 420 until a secondary form of authorization is successfully completed, such as contacting an approved user via a telephone call, text message, email or other such methods.

It is noted that FIG. 4 is merely one example of a procedure for preventing unauthorized access to a communication session. In other embodiments, a different number of modules may be used to perform the described actions. It is contemplated that features disclosed in FIG. 4 may be combined with the features disclosed in regards to FIGS. 2 and/or 3 to provide increased levels of protection. Although the preceding descriptions state that detection of higher risk activities results in a higher value for the risk level, it is contemplated that the risk level may be replaced, for example, with a confidence level that increases in value as confidence that a user attempting to access the user account is an approved user.

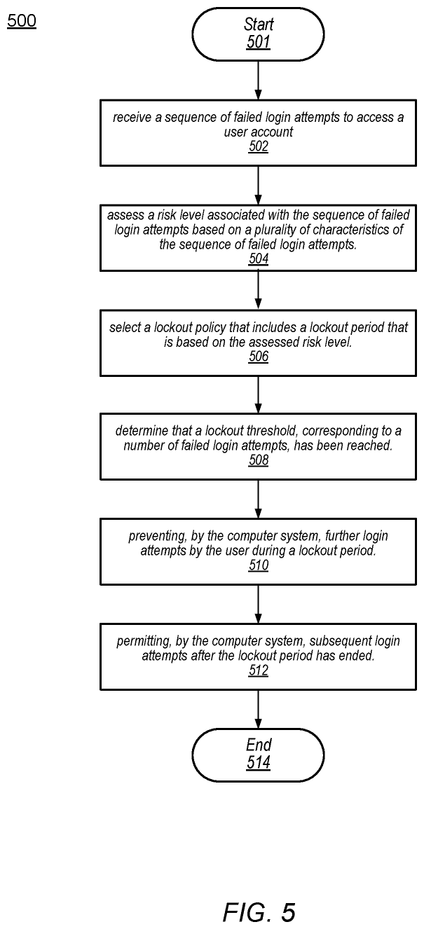

Moving now to FIG. 5, a flow diagram for an embodiment of a method for implementing a lockout policy that includes a lockout period is shown. Method 500 may be applied to a computer system, such as computer system 101 illustrated in FIGS. 1A and 1B or computer system 201 in FIG. 2. Referring collectively to FIG. 2 and the flow diagram in FIG. 5, the method begins in block 501.

A computer system receives a sequence of failed login attempts to access a user account (block 502). As illustrated, computer system 201 receives a sequence of failed login attempts from a user attempting to gain access to user account 220. The sequence of failed attempts may correspond to an approved user who has forgotten the correct account credentials, or may be a hacker attempting to gain unapproved access to user account 220.

The computer system assesses a risk level associated with the sequence of failed login attempts, basing the risk level on a plurality of characteristics of the sequence of failed login attempts (block 504). Computer system 201 may modify, using risk assessment module 210, a value of risk level 211. As illustrated, the value of risk level 211 increases in response to assessing a greater risk of the user being a hacker. In other embodiments, however, the risk level may be inverted such that lower values indicate a higher risk of the user being a hacker.

Risk assessment module 210 bases the value of risk level 211 on one or more detected characteristics associated with the failed login attempts. For example, risk assessment module 210 may increase risk level 211 in response to determining that the sequence of failed login attempts has occurred at a time of day at which user account 220 has not been previously accessed, or in response to determining that the sequence of failed login attempts has occurred at a geographic location from which the user account has not been previously accessed. Risk assessment module 210 may determine an identification value of a computing device and/or a network from which the failed login attempts are received. If the computing device or network has not been previously associated with the user account, then risk assessment module may increase risk level 211. Other characteristics, as described above, may also be used by risk assessment module 210 to set risk level 211.

Based on the assessed risk level, the computer system selects a lockout policy that includes a lockout period (block 506). Computer system 201 uses lockout policy enforcement module 215 to determine if and when user account 220 should be locked, thereby blocking further login attempts for a period of time. This period of time, i.e., the lockout period, is determined based on the value of risk level 211. As shown, lockout policies 225 include respective lockout periods, and lockout policy enforcement module 215 selects one of lockout policies 225 based on the value of risk level 211. A particular one of lockout policies 225 may be selected such that successively increasing values of risk level 211 correspond to successively increasing lockout periods. A longer lockout period in response to a higher assessed risk level may help to reduce a number of login attempts a hacker may be capable of initiating in a given amount of time. A long lockout period may discourage a hacker from making further login attempts. In some embodiments, risk level 211 may be one of a set of specified risk levels (e.g., “high,” “medium,” and “low” or “red,” “orange,” “yellow,” and “green”). In such embodiments, the selected lockout period may be one of a set of specified lockout periods, corresponding to one or more of the specified risk levels.

The computer system determines that a lockout threshold, corresponding to a number of failed login attempts, has been reached (block 508). As shown, lockout policy enforcement module 215 tracks a number of failed login attempts made by the user to access user account 220. If a successful login attempt is received from the user, then the tracked number may be reset to zero. In some embodiments, the number of failed login attempts may be accumulated from multiple users attempting to access the same user account 220. For example, if two or more hackers are engaging in a coordinated attempt to gain access to user account 220, then lockout policy enforcement module 215 may track a cumulative total of the failed attempts from both hackers. In other embodiments, the failed attempts from separate users to access user account 220 may be tracked and compared to the lockout threshold individually.

The computer system prevents further login attempts during a lockout period (block 510). In response to determining that a number of failed login attempts has reached the lockout threshold, lockout policy enforcement module 215 initiates a lockout period for a time duration set by the selected lockout policy, e.g., lockout period 227a. During the lockout period, computer system 201 does not accept further login attempts from any user to access user account 220.

The computer system permits subsequent login attempts after the lockout period has ended (block 512). After the lockout period expires, i.e., an amount of time elapses from initiating the lockout period that equals the value of lockout period 227a, lockout policy enforcement module 215 ends the lockout period and begins accepting further login attempts to user account 220. If the further login attempts include failed login attempts, lockout policy enforcement module 215 again tracks a number of failed attempts and compares them to the lockout threshold. In addition, risk assessment module 210 may update risk level 211 after each failed login attempt. The method ends in block 514.

It is noted that the embodiment of FIG. 5 is one example of receiving login credentials for accessing a user account. In some embodiments, operations may be performed in a different order. For example, operations associated with blocks 502, 504, and 506 may occur in an iterative manner, such as assessing a risk level after each one of the failed login attempts and subsequently selecting a different lockout policy if the risk level changes.

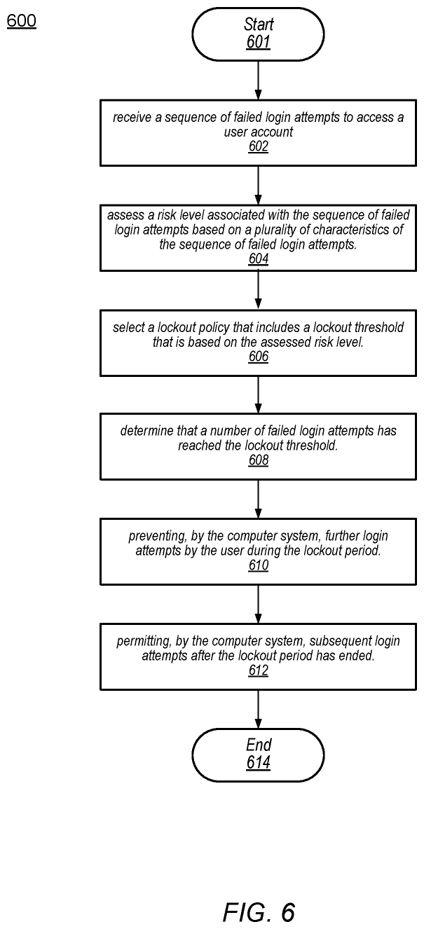

Turning now to FIG. 6, a flow diagram for an embodiment of a method that determines a lockout threshold based on an assessed risk level is depicted. Method 600 may be applied to a computer system, such as, for example, computer system 101 in FIG. 1 or computer system 301 illustrated in FIG. 3. Method 600 may, in some embodiments, combined with method 500 in FIG. 5. Referring collectively to FIG. 3 and method 600, the method begins in block 601.

Operations described in blocks 602 and 604 are similar to those described in blocks 502 and 504. In block 602, a computer system, (e.g., computer system 301) receives a sequence of failed login attempts to access a user account (e.g., user account 320). In block 604, computer system 301 assesses risk level 311 associated with the sequence of failed login attempts, basing risk level 311 on a plurality of characteristics of the sequence of failed login attempts. Similar to the description of method 500, computer system 301 uses risk assessment module 310 to assess a value of risk level 311 based on one or more detected characteristics associated with the failed login attempts. Such characteristics may include a time of day when the failed login attempts occur, a geographic location from which the failed login attempts occur, and other characteristics as described above.

Based on the assessed risk level, the computer system selects a lockout policy that includes a lockout threshold (block 606). Similar to method 500, computer system 301 uses lockout policy enforcement module 315 to determine if and when to lock user account 320. The lockout threshold determines a number of failed login attempts to user account 320 that are allowed before locking user account 320. In various embodiments, user account 320 may be locked when the number of failed attempts equals or exceeds the lockout threshold. The lockout threshold is determined based on the value of risk level 311. As shown, each of lockout policies 325a and 325b include respective lockout thresholds 328a and 328b. Lockout policy enforcement module 315 selects one of lockout policies 325 based on the value of risk level 311. For example, a lockout policy 325 may be selected such that the corresponding lockout threshold is a smaller number for higher risk levels, thereby allowing few failed attempts when the assessed risk of being hacked is high. As described above, risk level 311 may be one of a set of specified risk levels (e.g., “high,” “medium,” and “low” or “red,” “orange,” “yellow,” and “green”) in some embodiments. In such embodiments, the selected lockout threshold may be one of a set of specified lockout thresholds, corresponding to one or more of the specified risk levels.

The computer system determines that a number of failed login attempts has reached the selected lockout threshold (block 608). Computer system 301 uses lockout policy enforcement module 315 to track a number of failed login attempts made by the user to access user account 320. The tracked number may be reset to zero if a successful login attempt is received. As described above, the number of failed login attempts may be accumulated, in some embodiments, from multiple users attempting to access the same user account 220.

The computer system prevents further login attempts during a lockout period (block 610). In response to the determination that the number of failed login attempts has reached the lockout threshold, lockout policy enforcement module 315 initiates a lockout period. In some embodiments, method 600 may be combined with method 600 and the selected lockout policy, for example, lockout policy 325a, includes both lockout threshold 328a and lockout period 227a. A time duration for the lockout period is therefore set by lockout period 227a. In other embodiments, the lockout period may be set to a constant value or determined by other means. During the lockout period, computer system 301 does not accept further login attempts from any user to access user account 320.

The computer system permits subsequent login attempts after the lockout period has ended (block 612). After the lockout period expires, lockout policy enforcement module 315 ends the user account lockout and accepts further login attempts to user account 320. Lockout policy enforcement module 315 resumes tracking the number of failed attempts (restarting the count at zero) and comparing the number to the lockout threshold. The value of the lockout threshold may remain the same as before the successful login or may restart at a default initial value. In addition, risk assessment module 310 may update risk level 311 after each failed login attempt. The method ends in block 614.

It is noted that method 600 of FIG. 6 is merely an example. As described, method 600 may, in some embodiments, be combined with operations of method 500 in FIG. 5. Some operations, in some embodiments, may be performed in parallel or may be performed in a different order.

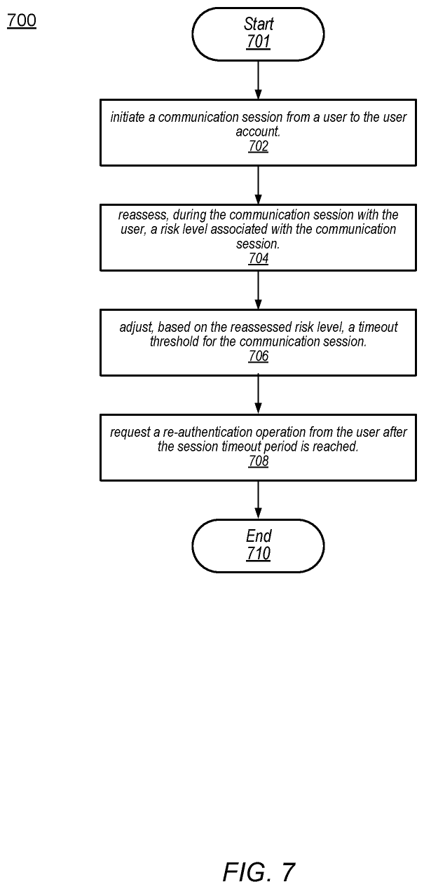

The methods of FIGS. 5 and 6 describe operations performed in response to a user attempting to login to a user account. Proceeding now to FIG. 7, a flow diagram for an embodiment of a method for monitoring a communication session after a successful login attempt is shown. Method 700 may be applied to a computer system, such as, for example, computer systems 101 or 401 illustrated in FIGS. 1 and 4, respectively. In some embodiments, the operations of method 700 may be combined with operations from methods 500 and/or 600. Referring collectively to FIG. 4 and method 700, the method begins in block 701.

A computer system initiates a communication session from the user to the user account (block 702). After receiving, from a user, valid account credentials for user account 420, computer system 401 establishes communication session 422. In the course of receiving the valid account credentials, computer system 401 may receive one or more failed login attempts from the user. Risk assessment module 410 may, therefore, have assessed a risk level associated with the user and assigned a value to risk level 411. At the start of communication session 422, session timeout enforcement module 415 may use a current value of risk level 411 to select a session timeout policy 425, for example, session timeout policy 425a that includes session timeout period 427a. Session timeout enforcement module 415 sets a session timeout period using session timeout period 427a.

The computer system reassesses a session risk level associated with the communication session (block 704). While communication session 422 is active, risk assessment module 410, as shown, may reassess risk level 411 one or more times based on activity of the user. For example, risk assessment module 410 may reassess risk level 411 based on operations performed by the user and/or a geographic location of the user. If risk assessment module 410 determines that suspicious activity is or is not occurring, then risk level 411 may be increased or decreased accordingly.

The computer system adjusts, based on the reassessed session risk level, the session timeout period based on operations performed in the user account during the communication session (block 706). If risk assessment module 410 adjusts risk level 411, then the modified value is sent to session timeout enforcement module 415, which may then select a different session timeout policy based on adjusted risk level 411. For example, in response to an increase in risk level 411, a session timeout policy 425 with a shorter timeout period may be selected.

The computer system requests a re-authentication operation from the user after the session timeout period is reached (block 708). In response to a currently selected session timeout period expiring (relative to a last successful authentication operation), session timeout enforcement module 415 initiates a re-authentication operation. The re-authentication operation may include a request to the user to re-enter valid account credentials. In some embodiments, the re-authentication operation may include a request for the user to perform additional or alternative means of verifying that the user is authorized to access user account 420. Alternative means may include sending a passcode to a known or registered device associated with the user, and/or asking the user to answer one or more pre-established questions. If the user successfully completes the re-authentication operation, then communication session continues. In some embodiments, risk assessment module 410 may reassess risk level 411 based on the successful re-authentication operation. If the re-authentication operation is unsuccessful, then computer system 401 terminates communication session 422. In some embodiments, computer system 401 may additionally send an alert to an approved user via a phone call, a text message, an email, and the like. The method ends in block 710.

It is noted that the method of FIG. 7 is an example for demonstrating the disclosed embodiments. In other embodiments, some operations may be repeated. For example, operations in blocks 704 and 706 may repeat at a scheduled interval and/or in response to a particular event or action by the user.

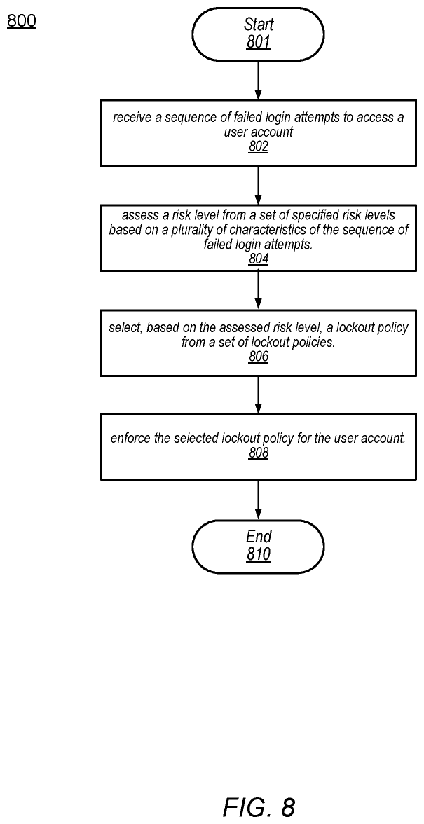

As previously stated, operations of the various disclosed methods may be combined in some embodiments. Method 800 depicted in FIG. 8 illustrates a flow diagram for an embodiment of a method that implements a lockout policy that may include a variety of operations. Method 800 may be applied to a suitable computer system, such as, for example, any of the disclosed computer systems 101, 201, 301, or 401 illustrated in FIGS. 1-4, respectively. The operations of method 800 may include or be combined with operations from any methods disclosed herein. Referring collectively to FIG. 1 and method 800, the method begins in block 801.

A computer system receives a sequence of failed login attempts to access a user account (block 802). As has been previously disclosed above, a computer system, such as computer system 101, receives a sequence of failed login attempts such as failed login attempts 135. The attempts, as illustrated are received from user computer 130 who is attempting to access user account 120.

The computer system then assesses a risk level from a set of specified risk levels based on a plurality of characteristics of the sequence of failed login attempts (block 804). Computer system 101 may select, based on characteristics that have been described herein, a particular risk level from a set of predetermined risk levels. The predetermined risk levels may include, for example, two levels: a high risk and a low risk. Other embodiments may rate risk levels from integers one to ten, ten being the highest risk. Any suitable number of risk levels may be included in various embodiments.

Based on the assessed risk level, computer system 101 selects a lockout policy from a set of lockout policies (block 806). In some embodiments, computer system 101 may include a one-for-one mapping of risk levels to lockout policies. For example, an embodiment that includes two levels, high and low, may include two corresponding lockout policies. In some embodiments, a number of risk levels may be mapped to smaller number of lockout policies. An embodiment that rates risk levels from one to ten may, in some embodiments, include four lockout policies, A-D. A mapping is created to link one or more of the risk levels to one of the lockout policies, e.g., risk levels 1-3 map to policy A, levels 4-5 to policy B, levels 6-7 to policy C, and levels 8-10 to policy D. This mapping may change in response to current information. For example, if user computer 130 informs account managers running computer system 101 that they will be travelling during a particular time period, then the mappings may be relaxed during the time period such that increased risk levels due to access from non-typical geographic locations and/or times of day map to lower risk lockout policies. Furthermore, if account managers running computer system 101 have noticed increased hacking activity, the mappings may be remapped to more stringent lockout policies for a same risk level.

The computer system enforces the selected lockout policy for the user account (block 808). The selected lockout policy may include one or more settings for parameters associated with the account lockout process. As previously disclosed, lockout policies may include settings for lockout thresholds that determine when to lock a user account, and lockout periods that determine how long an account remains locked after a number of failed attempts reaches the threshold. The lockout policies may include additional settings in some embodiments. For example, the lockout policy may include an indication for enabling one or more additional steps for user computer 130 to take to unlock user account 120, such as answer additional questions or entering a code that computer system 101 emails or texts to user computer 130. The lockout policy may include an indication if user account 120 is locked indefinitely or if new account credentials are to be requested upon a successful login. For example, after a successful login preceded by a high-risk assessment, user computer 130 may be prevented from changing account credentials, thereby preventing a successful hacker from changing the credentials and locking an approved user from accessing the account. The method ends in block 810.

It is noted that method 800 of FIG. 8 is merely an example. As described, method 800 may, in some embodiments, be combined with operations of method 700 in FIG. 7. In other embodiments, some operations may be repeated. For example, operations in blocks 804 and 806 may repeat in response to a particular action by the user or an elapse of a time interval.

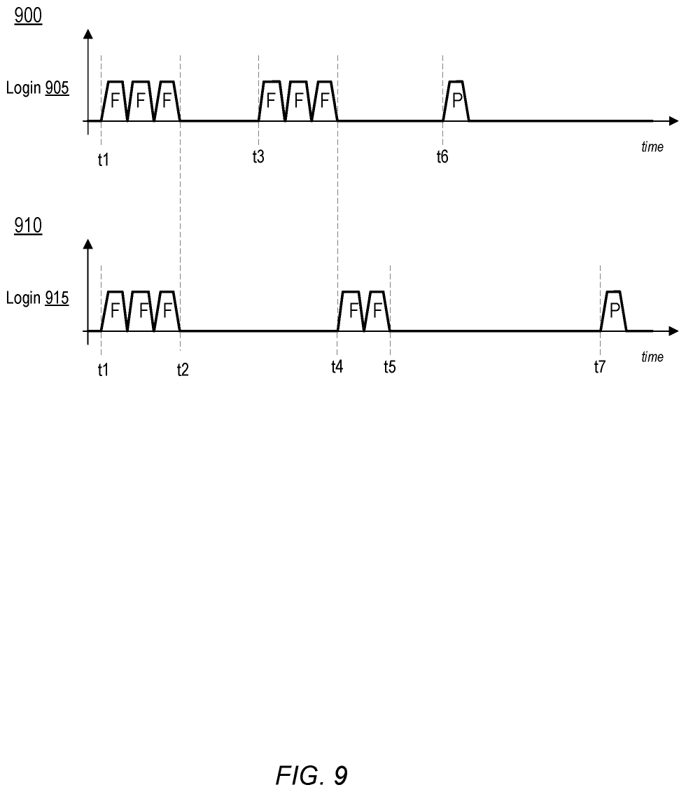

Two examples of lockout policy enforcement are shown in charts 900 and 910 of FIG. 9. Moving to FIG. 9, charts 900 and 910 depict login attempts made by a user to access a user account. Login attempts 905 correspond to a sequence of failed login attempts that are assessed as low risk. Login attempts 915 correspond to a sequence of failed login attempts that are assessed as high risk. The high state in the charts depicts reception of account credentials from a user. The corresponding “F” or “P” indicates if the received credentials are invalid and therefore a failed attempt (“F”), or are valid and therefore a passing attempt (“P”). The illustrated charts in FIG. 9 may correspond to any of the computing systems disclosed herein.

Referring to the example of chart 900 in combination with system 100 of FIG. 1A, a sequence of login attempts 905 is received by computer system 101 from user computer 130 between times t1 and t2. During these failed attempts, risk assessment module 110 sets a risk level for the failed attempts which causes lockout policy enforcement module 115 to select a lockout policy that sets a lockout threshold of three failed attempts. After the third failed attempt, lockout policy enforcement module 115 enforces a lockout period for an amount of time that is set by a lockout period value included in the selected lockout policy. At time t3, the lockout period elapses and user computer 130 sends additional login attempts. Risk assessment module 110 continues to assess the risk level and lockout policy enforcement module 115 selects a new lockout policy based on a reassessed risk level. The new lockout policy maintains a lockout threshold of three, but extends the lockout period after the threshold is reached. Another three failed login attempts are received between t3 and t4 and lockout policy enforcement module 115 initiates another lockout period from t4 to t6, based on the longer lockout period. A successful login attempt is received at time t6 and computer system 101 initiates a communication session between user computer 130 and user account 120.

In other embodiments, the risk level, and therefore, the lockout policy, may remain unchanged after the first lockout period elapses. However, the originally selected lockout policy may include a different value for the lockout period for each subsequent occurrence of reaching the lockout threshold. The longer second lockout period from t4 to t5 as compared to first lockout period from t2 to t3 may therefore, be included in the same lockout policy.

Referring to the example of chart 910, a sequence of login attempts 915 is received by computer system 101 from user computer 130 between times t1 and t2 the same as shown for chart 900. As illustrated in login attempts 915, however, risk assessment module 110 assesses a higher risk level for login attempts 915 than is assessed for login attempts 905. The lockout policy that is selected by lockout policy enforcement module 115 includes a same value of three for the lockout threshold, but includes a longer lockout period than used for login attempts 905. At time t2, therefore, user account 120 is locked for a period of time from t2 to t4.

When the lockout period ends at time t4, user computer 130 sends additional login attempts. Risk assessment module 110 continues to assess the risk level associated with these additional failed attempts and lockout policy enforcement module 115 selects a new lockout policy with a lower lockout threshold (two) and a longer lockout period. User account 120 is locked again at time t5 after two additional failed login attempts. The second lockout period lasts from time t5 to t7. At time t7, a successful login attempt is received and a communication session between user computer 130 and user account 120 is established.

As described for chart 900, in other embodiments, the risk level, and therefore, the lockout policy, may remain unchanged after the first lockout period elapses. The originally selected lockout policy may, in some embodiments, include both a different value for the lockout period and the lockout threshold for each subsequent occurrence of reaching the lockout threshold.

It is noted that the two charts in FIG. 9 are merely examples used to demonstrate the disclosed concepts. The illustrated time periods, t1 to t7, are intended only to indicate an order in which events occur, and not a measured unit of time. Other embodiments may differ in one or more characteristics, such as lockout thresholds and lockout periods.

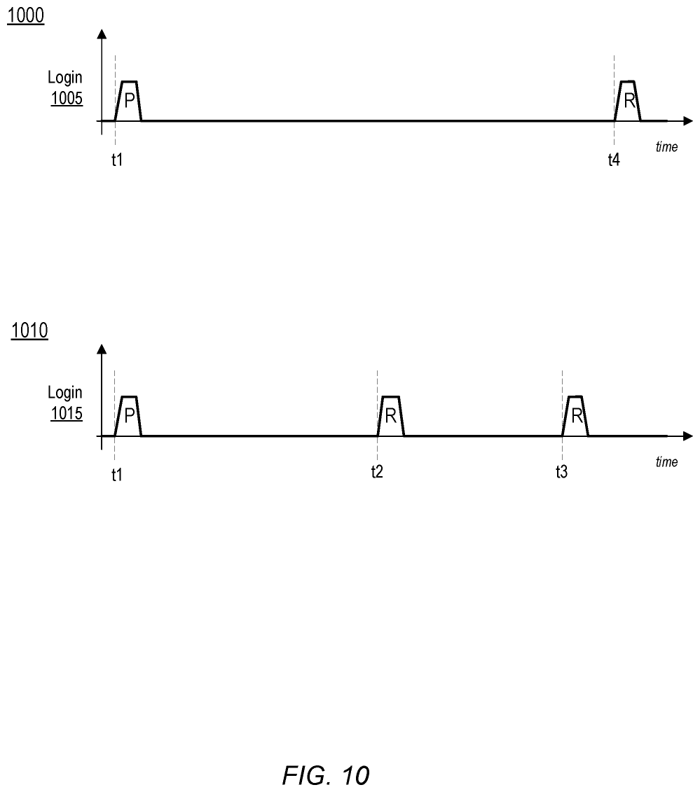

Similar to FIG. 9, two examples of session timeout policy enforcement are shown in charts 1000 and 1010 of FIG. 10. Charts 1000 and 1010 of FIG. 10 depict an initial passing login (“P”) made by a user to access a user account, followed by one or more re-authentication operations. Login attempts 1005 correspond to a re-authentication operation associated with an assessed low risk user, while login attempts 1015 correspond to a re-authentication operation associated with an assessed higher risk user. Charts 1000 and 1010 in FIG. 10 may correspond to any of the disclosed computing systems.

Referring to system 150 of FIG. 1B and to chart 1000, as illustrated by login attempts 1005, a valid login attempt is received by computer system 101 from user computer 130 at time t1. Computer system 101 establishes communication session 140. Based on various information, such as an assessed risk level corresponding to failed login attempts prior to time t1, a physical location of user computer 130, computer device and/or network IDs, and other similar data, risk assessment module 110 assesses a risk level associated with user computer 130. Session timeout enforcement module 117 selects a particular session timeout policy based on the assessed risk level, and sets a session timeout period based on a value included in the timeout policy. At time t4, the session timeout period elapses and a re-authentication operation is performed, during which user computer 130 is requested to re-enter valid account credentials to continue communication session 140.

When the risk level is increased, as shown in chart 1010, the session timeout period decreases. At time t1, as shown by login attempts 1015, computer system 101 receives an initial valid login attempt. Communication session 140 is established and risk assessment module 110 assesses the current risk level. Session timeout enforcement module 117 selects a session timeout policy and sets the session timeout period accordingly. In the example of chart 1010, a higher risk level than that of chart 1000 results in a shorter session timeout period. User computer 130 is requested to re-authenticate at time t2. Risk assessment module 110 continues to assess the risk level and, in the illustrated embodiment, increases the risk level after time t2. The increased risk level results in session timeout enforcement module 117 selecting a new session timeout policy with a shorter session timeout period. User computer 130 is requested to re-authenticate again at time t3. As described herein, the increase in the risk level after time t2 may be caused by operations user computer 130 performs during communication session 140, due to a location of user computer 130, due to a computer or network ID used by user computer 130, or similar other characteristics described above.

Similar to the lockout policy previously described, computer system 101 may, in some embodiments, include a one-for-one mapping of risk levels to session timeout policies. In other embodiments, a number of risk levels may be mapped to smaller number of lockout policies. In either type of embodiment, the mapping may change in response to current information. For example, if account managers running computer system 101 are aware of an increased hack threat, the mappings may be remapped to select less forgiving lockout policies for a same risk level. Reducing the session timeout period in response to an increased risk level may help to prevent or mitigate unauthorized activity during an established communication session. When risk of a session hijacking is low, the session timeout may, conversely, be extended, thereby reducing interruptions to activities being performed by user computer 130.

It is noted that charts 1000 and 1010 in FIG. 10 are merely examples. As disclosed above in regards to FIG. 9, times t1 through t4 are not intended to represent a particular amount of time, but rather an order of occurrence of the various login attempts. Although an amount of time for each login attempt is shown to be approximately equal, in other embodiments each login attempt and re-authentication operation may differ in length.

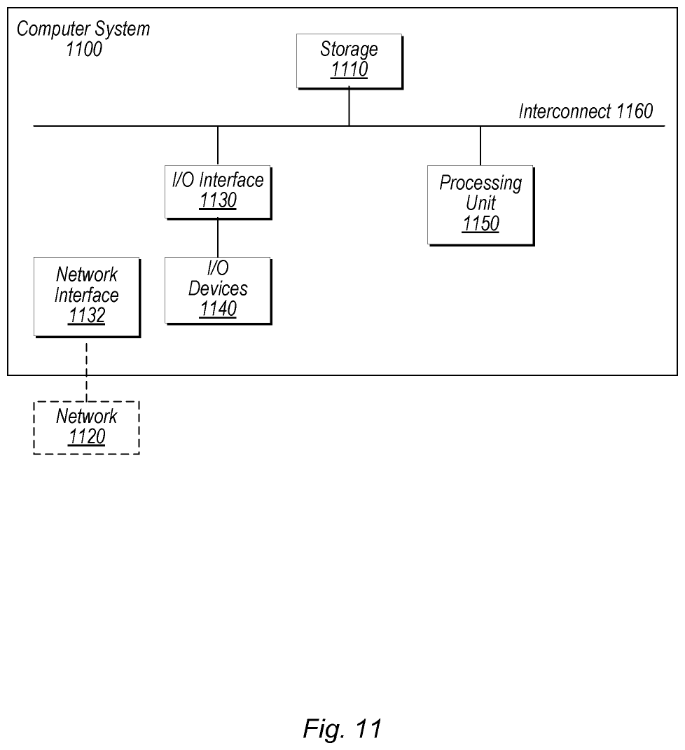

Turning to FIG. 11, a block diagram of an example computer system is illustrated. Computer device 1100, in various embodiments, may correspond to any of the computer systems or computing devices disclosed herein, such as, for example, computer systems 101, 201, 301, or 401, in FIGS. 1-4. Computing device 1100 may be any suitable type of device, including, but not limited to, a personal computer system, desktop computer, mainframe computer system, web server, workstation, or network computer. Furthermore, in some embodiments, computing device 1100 may correspond to a mobile device such as, e.g., a tablet computer, smart phone, a laptop computer, or a wearable computer system. As shown, computing device 1100 includes processing unit 1150, storage 1110, input/output (I/O) interface 1130 coupled via an interconnect 1160 (e.g., a system bus). I/O interface 1130 may be coupled to one or more I/O devices 1140. Computing device 1100 further includes network interface 1132, which may be coupled to network 1120 for communications with, for example, other computing devices.

In various embodiments, processing unit 1150 includes one or more processors. In some embodiments, processing unit 1150 includes one or more coprocessor units. In some embodiments, multiple instances of processing unit 1150 may be coupled to interconnect 1160. Processing unit 1150 (or each processor within 1150) may contain a cache or other form of on-board memory. In some embodiments, processing unit 1150 may be implemented as a general-purpose processing unit, and in other embodiments it may be implemented as a special purpose processing unit (e.g., an ASIC). In general, computing device 1100 is not limited to any particular type of processing unit or processor subsystem.

As used herein, the terms “processing unit” or “processing element” refer to circuitry configured to perform operations or to a memory having program instructions stored therein that are executable by one or more processors to perform operations. Accordingly, a processing unit may be implemented as a hardware circuit implemented in a variety of ways. The hardware circuit may include, for example, custom very-large-scale integration (VLSI) circuits or gate arrays, off-the-shelf semiconductors such as logic chips, transistors, or other discrete components. A processing unit may also be implemented in programmable hardware devices such as field programmable gate arrays, programmable array logic, programmable logic devices, or the like. A processing unit may also be configured to execute program instructions from any suitable form of non-transitory computer-readable media to perform specified operations.

Storage subsystem 1110 is usable by processing unit 1150 (e.g., to store instructions executable by and data used by processing unit 1150). Storage subsystem 1110 may be implemented by any suitable type of physical memory media, including hard disk storage, floppy disk storage, removable disk storage, flash memory, random access memory (RAM-SRAM, EDO RAM, SDRAM, DDR SDRAM, RDRAM, etc.), ROM (PROM, EEPROM, etc.), and so on. Storage subsystem 1110 may consist solely of volatile memory in one embodiment. Storage subsystem 1110 may store program instructions executable by computing device 1100 using processing unit 1150, including program instructions executable to cause computing device 1100 to implement the various techniques disclosed herein.

In some embodiments, methods and systems disclosed herein may be implemented in whole or in part with computer code that is executable on one or more processor circuits such as processing unit 1150. Thus, various operations described herein may be performed by executing program instructions stored on a non-transitory computer-readable medium and executed by processing unit 1150. The program instructions may be stored in storage subsystem 1110, or provided on any media capable of sharing program code, such as a compact disk (CD) medium, digital versatile disk (DVD) medium, a floppy disk, a flash-based storage, and the like. Additionally, the entire program code, or portions thereof, may be transmitted and downloaded from a software source such as, e.g., via the Internet, or a file transfer protocol (FTP) server, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a mobile computing system such as, for example, in C, C+, HTML, Java, JavaScript, or other such programming languages.

I/O interface 1130 may represent one or more interfaces and may be any of various types of interfaces configured to couple to and communicate with other devices, according to various embodiments. In one embodiment, I/O interface 1130 is a bridge chip from a front-side to one or more back-side buses. I/O interface 1130 may be coupled to one or more I/O devices 1140 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

It is noted that FIG. 11 is merely an example for demonstrating disclosed concepts. Only components and data movement necessary to illustrate these concepts are shown in FIG. 11. Additional and/or different components or data movements may be included in other embodiments.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
receiving, by a computer system, a sequence of failed login attempts to access a user account;
assessing, by the computer system, a risk level associated with the sequence of failed login attempts, wherein the risk level is assessed based on a plurality of characteristics of the sequence of failed login attempts;
selecting, by the computer system, a lockout policy that includes a lockout period that is based on the assessed risk level;
determining, by the computer system, that a lockout threshold has been reached, wherein the lockout threshold corresponds to a number of failed login attempts;
in response to determining that the lockout threshold has been reached, preventing, by the computer system, further login attempts during the lockout period; and
permitting, by the computer system, subsequent login attempts after the lockout period has ended.

2. The method of claim 1, wherein the lockout policy specifies the lockout threshold, and wherein the lockout threshold is based on the assessed risk level.

3. The method of claim 1, wherein the risk level is one of a set of specified risk levels, and wherein the lockout period is one of a set of specified lockout periods, and wherein the lockout policy is selected such that successively increasing risk levels correspond to successively increasing lockout periods.

4. The method of claim 1, wherein the assessing includes increasing the assessed risk level based on a time of day of access for at least one of the sequence of failed login attempts.

5. The method of claim 1, wherein the assessing includes increasing the assessed risk level based on a geographic location associated with at least one of the sequence of failed login attempts.

6. The method of claim 1, further comprising, in response to receiving a successful login attempt to the user account:
initiating a communication session to the user account;
assessing a session risk level associated with the communication session; and
determining, based on the assessed session risk level, a session timeout period for the communication session.

7. The method of claim 6, further comprising adjusting, by the computer system, the session timeout period based on operations performed in the user account during the communication session.

8. A non-transitory, computer-readable medium storing instructions that, when executed by a server computer system, cause the server computer system to perform operations comprising:
detecting a sequence of failed login attempts to access a user account originating from a user computer, wherein the failed login attempts originate from a user computer;
assessing a risk level associated with the user computer based on a plurality of characteristics of the sequence of failed login attempts;
selecting a lockout policy that specifies a lockout period that is based on the assessed risk level;
initiating the lockout period in response to determining that a threshold number of failed login attempts has been reached, wherein the initiating blocks further login attempts to the user account for a duration of the lockout period; and
accepting subsequent login attempts to the user account after the lockout period has elapsed.

9. The computer-readable medium of claim 8, further comprising setting the threshold number based on a lockout threshold that is determined based on the assessed risk level.

10. The computer-readable medium of claim 8, further comprising selecting the lockout policy from a set of lockout policies, each lockout policy of the set including a respective lockout period, wherein the risk level is one of a set of specified risk levels, and wherein the lockout policy is selected such that successively increasing risk levels correspond to successively increasing lockout periods.

11. The computer-readable medium of claim 8, wherein assessing the risk level comprises increasing the risk level based on an identification value of the user computer.

12. The computer-readable medium of claim 8, wherein assessing the risk level comprises increasing the risk level based on an identification value of a network in use by the user computer.

13. The computer-readable medium of claim 8, further comprising, in response to detecting a successful login attempt by the user computer:
establishing a communication session from the user computer to the user account;
reassessing a session risk level associated with the user computer; and
determining, based on the reassessed session risk level, a session timeout period for the communication session.

14. A method, comprising:
receiving, by a computer system from a user computer, a sequence of failed login attempts to access a user account;
assessing, by the computer system, a risk level from a set of specified risk levels, wherein the risk level is assessed based on a plurality of characteristics of the sequence of failed login attempts;
selecting, by the computer system based on the assessed risk level, a lockout policy from a set of lockout policies; and
enforcing, by the computer system, the selected lockout policy for the user account.

15. The method of claim 14, wherein each lockout policy of the set of lockout policies includes a respective lockout period that specifies a period of time to enforce a lockout of the user account, and wherein the lockout policy is selected such that successively increasing risk levels correspond to successively increasing lockout periods.

16. The method of claim 14, wherein each lockout policy of the set of lockout policies includes a respective lockout threshold that specifies a number of failed login attempts that may be received before enforcing a lockout of the user account, and wherein the lockout policy is selected such that successively increasing risk levels correspond to successively decreasing lockout periods.

17. The method of claim 14, wherein the plurality of characteristics includes a time of day when at least one of the failed login attempts is received and a determined location of the user computer.

18. The method of claim 14, further comprising, in response to receiving a successful login attempt to the user account:
initiating a communication session from the user computer to the user account;
reassessing the risk level associated with the user computer; and
determining, based on the reassessed risk level, a session timeout period for the communication session.

19. The method of claim 18, further comprising requesting, by the computer system, a re-authentication operation from the user computer after the session timeout period is reached.

20. The method of claim 18, further comprising increasing, by the computer system, the risk level based on a determination that a geographic location of the user computer has changed during the communication session.
